(19) United States
(12) Patent Application Publication
(10) Pub. No.: US 2004/0075962 A1
(43) Pub. Date: Apr. 22, 2004

(54) Universal optically isolated input circuit

(76) Inventor: David Coutu, East Hampton, CT (US)

Correspondence Address: RICHARD MENELLY, 18 SACO RD., ALFRED, ME, 04002, US

(21) Appl. No.: 10/166,354

(22) Filed: May 15, 2002

(51) Int. Cl. H02H 7/00

(52) U.S. Cl. 361/18

(57) ABSTRACT

The invention comprises a printed circuit board having diode steering logic at the input and an optical coupler arrangement at the output thereof. A constant current source is arranged intermediate the diode steering logic and the optical coupler to maintain a constant current source to the optical coupler that is independent of input voltage.

### BACKGROUND OF THE INVENTION

Optically isolated circuits are used for connection with electrical devices such as motor control circuits, motor drivers, telephone circuits and the like to provide an electrical barrier between the electrical input and the associated equipment.

One example of an optical isolation circuit for use with telephones is found in U.S. Pat. No. 5,465,298 entitled “Solid State Isolation Device Using Optical Isolators.”

An electrical stepper motor is described within U.S. Pat. No. 6,002,186 entitled “Electrical Stepper Motor Having a Cylindrical Magnetic Rotor with a Pair of Cups Made of Magnetic Material”

A motor controller unit for controlling operation of a stepper motor arrangement is found within U.S. Pat. No. 5,657,193 entitled “Electronic Control Module for Motor Controller Unit”.

When an electrical stepper motor is supplied to a customer, the control circuit is supplied with an optical coupler and the customer then provides an input circuit to accommodate a certain DC voltage input level which varies throughout the electrical industry. Some such input circuits are designed to allow for a so-called “sinking” input while other input circuits are designed to allow for so-called “sourcing” input at various DC voltage levels.

It would be economically advantageous to provide an optically isolated input circuit, which would allow connection with both sinking and sourcing inputs over a wide range of input voltages without requiring a customized electrical interface circuit.

One purpose of the instant invention accordingly, is to provide a universal optically isolated input circuit to allow connection with a wide variety of input sources without requiring such customized electrical interface circuitry.

### SUMMARY OF THE INVENTION

The invention comprises a printed circuit board having diode steering logic at the input and an optical coupler arrangement at the output thereof. A constant current source is arranged intermediate the diode steering logic and the optical coupler to maintain a constant current source to the optical coupler that is independent of input voltage. In one embodiment, a full wave bridge rectifier is employed to provide the steering logic function.

### BRIEF DESCRIPTION OF THE DRAWINGS

FIG. 1 is a schematic representation of the universal optically isolated input circuit arrangement according to the invention.

### DESCRIPTION OF THE PREFERRED EMBODIMENT

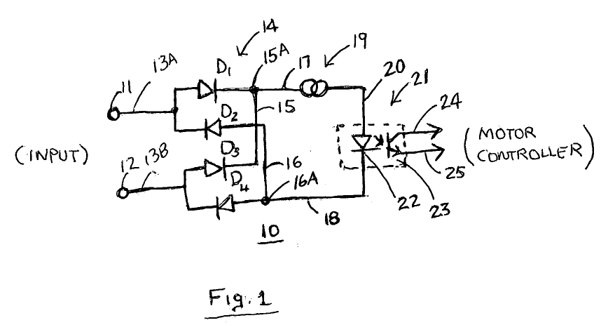

The universal optically isolated input circuit 10, according to the invention is depicted in FIG. 1. A pair of inputs 11, 12 connect with diodes D1-D4 within the bridge rectifier 14 in the following manner. Input conductor 13A connects with the anode of D1 and with the cathode of D2, while input conductor 13B connects with the anode of D3 and with the cathode of D4. Conductor 15 connects the cathodes of D1 and D3 in parallel while conductor 16 connects the anodes of D2 and D4 in parallel, to complete the bridge rectifier 14.

Conductors 17, 18 connect the rectifier output nodes 15A, 16A in series relation with a current source 19 and with the opto-isolator 21 via conductor 20. Conductor 20 interconnects current source 19 the anode of the LED 22 and conductor 18 connects with the cathode of the LED 22 to complete the input circuit 10. The phototransistor 23 within the opto-isolator 21 is arranged for connection with the motor controller unit (not shown) over the output conductors 24, 25.

Although the input circuit 10 is depicted for connection with a motor controller unit, it is to be understood that the input circuit can also be employed with other equipment requiring such electrical isolation, such as motor driver relays and telephone circuits.

A universal optically isolated input circuit has been described herein for connection with sourcing and sinking input sources at various voltage levels without requiring additional adaptive circuitry.

1. A universal optically isolated input circuit comprising:
a bridge rectifier circuit having an input and an output, said bridge rectifier input being arranged for connection with an external circuit having varying input current values;
an optical isolator circuit having an input and an output, said optical isolator input connecting with said bridge rectifier output, said optical isolator output being arranged for connection with associated electrical equipment; and
a current source interconnecting said bridge rectifier circuit and said optical isolator circuit for maintaining a constant current value at said optical isolator output independent of said varying input current values.

2. The universal optically isolated input circuit of claim 1 wherein said bridge rectifier input provides diode steering logic to said varying input values.

3. The universal optically isolated input circuit of claim 1 wherein said constant current source comprises a battery.

4. The universal optically isolated input circuit of claim 1 wherein said bridge rectifier comprises first, second, third and fourth diodes, whereby said first and third diodes are cathode-interconnected and said second and fourth diodes are anode-interconnected.

5. The universal optically isolated input circuit of claim 4 wherein said optical coupler comprises an LED and a phototransistor.

6. The universal optically isolated input circuit of claim 5 wherein said first and third diodes connect with a cathode on said LED and said second and fourth diodes connect with an anode on said LED.

7. The universal optically isolated input circuit of claim 5 wherein said phototransistors include a pair of outputs, said phototransistor outputs being connected with a motor controller relay.

8. The universal optically isolated input circuit of claim 6 wherein said current source interconnects between said first and third diodes and said LED anode.

9. A method for providing optical isolation between a motor controller unit and an input current source comprising the steps of:
connecting a bridge rectifier with a source of input current;
connecting an opto-isolator to a motor controller unit; and
interconnecting said opto-isolator and said bridge rectifier by means of a constant current source.
